(19) United States
(12) Patent Application Publication
(10) Pub. No.: US 2014/0120264 A1
(43) Pub. Date: May 1, 2014

(54) PLATING APPARATUS, PLATING METHOD AND STORAGE MEDIUM

(71) Applicants: Yuichiro Inatomi, Nirasaki-shi (JP); Takashi Tanaka, Nirasaki-shi (JP); Osamu Kuroda, Koshi (JP); Mitsuaki Iwashita, Nirasaki (JP); Yusuke Saito, Nirasaki-shi (JP)

(72) Inventors: Yuichiro Inatomi, Nirasaki-shi (JP); Takashi Tanaka, Nirasaki-shi (JP); Osamu Kuroda, Koshi (JP); Mitsuaki Iwashita, Nirasaki (JP); Yusuke Saito, Nirasaki-shi (JP)

(73) Assignee: TOKYO ELECTRON LIMITED, Tokyo (JP)

(21) Appl. No.: 14/128,109

(22) PCT Filed: Jun. 7, 2012
(86) PCT No.: PCT/JP2012/064706

§ 371 Date: Jan. 2, 2014

(30) Foreign Application Priority Data
Jun. 24, 2011 (JP) 2011-140678

(51) Int. Cl. B05C 11/10

(52) U.S. Cl. CPC B05C 11/1039
USPC 427/345; 118/600; 118/712; 118/697

(57) ABSTRACT

A plating apparatus 20 has a substrate holding/rotating device 110 configured to hold and rotate a substrate 2 and a plating liquid supplying device 30 configured to supply a plating liquid 35 onto the substrate 2. The plating liquid supplying device 30 has a supply tank 31 configured to store therein the plating liquid 35 to be supplied onto the substrate 2, a discharge nozzle 32 configured to discharge the plating liquid 35 onto the substrate 2 and a plating liquid supplying line 33 through which the plating liquid 35 within the supply tank 31 is supplied into the discharge nozzle 32. Further, an ammonia gas storage unit 170 is connected to the supply tank 31, and a concentration of an ammonia component within the plating liquid 35 stored in the supply tank 31 can be maintained within a preset target range.

### TECHNICAL FIELD

The embodiments described herein pertain generally to a plating apparatus, a plating method and a storage medium for performing a plating process by supplying a plating liquid onto a surface of a substrate.

### BACKGROUND ART

Recently, a wiring is formed on a substrate such as a semiconductor wafer or a liquid crystal substrate to form a circuit on a surface of the substrate. The wiring is typically made of, instead of aluminum, copper having low electric resistance and high reliability. Since, however, copper tends to be easily oxidized as compared to aluminum, it is required to plate a surface of the copper wiring with a metal having high electromigration resistance in order to suppress the surface of the copper wiring from being oxidized.

In general, a plating liquid containing metal ions of the metal to be plated on the surface of the copper wiring contains, besides the metal ions, an ammonia component that form a complex of the metal ions. The plating liquid is collected and reused for the purpose of cost cut.

Since, however, a property of the plating liquid is very unstable, the property of the plating liquid would be changed and degraded even if the plating liquid is just circulated within an apparatus to be collected and reused. In Patent Document 1, by introducing an inert gas into a plating liquid storage tank and substituting an atmosphere within the plating liquid storage tank with the inert gas, degradation of the plating liquid, which might be caused by the dissolution of carbon dioxide in the air in the plating liquid, is suppressed.
Patent Document 1: Japanese Patent Laid-open Publication No. 2007-051346

### DISCLOSURE OF THE INVENTION

### Problems to be Solved by the Invention

In view of the foregoing, example embodiments provide a plating apparatus, a plating method and a storage medium configured to reuse a plating liquid by maintaining a concentration of an ammonia component in the plating liquid.

### Means for Solving the Problems

In one example embodiment, a plating apparatus performs a plating process by supplying a plating liquid containing at least an ammonia component onto a substrate. The plating apparatus includes a substrate accommodating unit configured to accommodate therein the substrate; a plating liquid supplying device, configured to supply the plating liquid onto the substrate accommodated in the substrate accommodating unit, having a supply tank configured to store therein the plating liquid to be supplied onto the substrate, a discharge nozzle configured to discharge the plating liquid onto the substrate and a plating liquid supplying line through which the plating liquid within the supply tank is supplied into the discharge nozzle; a plating liquid draining device configured to drain the plating liquid supplied onto the substrate out of the substrate accommodating unit and supply the drained plating liquid to the supply tank of the plating liquid supplying device; an ammonia gas storage unit which is filled with an ammonia gas and hermetically sealed; and an ammonia gas line through which the ammonia gas from the ammonia gas storage unit is supplied into the supply tank.

In another example embodiment, a plating method performs a plating process by supplying a plating liquid containing at least an ammonia component onto a substrate. The plating method includes accommodating the substrate in a substrate accommodating unit; discharging the plating liquid within a supply tank onto the substrate through a discharge nozzle; collecting the plating liquid supplied onto the substrate from the substrate accommodating unit through a plating liquid draining device; adjusting a composition of the collected plating liquid by exposing the collected plating liquid to an ammonia gas; and supplying the plating liquid of which the composition is adjusted into the discharge nozzle.

In yet another example embodiment, a computer-readable storage medium has stored thereon a computer-executable instructions that, in response to execution, cause a plating apparatus to perform a plating method by supplying a plating liquid containing at least an ammonia component onto a substrate. Further, the plating method includes accommodating the substrate in a substrate accommodating unit; discharging the plating liquid within a supply tank onto the substrate through a discharge nozzle; collecting the plating liquid supplied onto the substrate from the substrate accommodating unit through a plating liquid draining device; adjusting a composition of the collected plating liquid by exposing the collected plating liquid to an ammonia gas; and supplying the plating liquid of which the composition is adjusted into the discharge nozzle.

### Effect of the Invention

In accordance with example embodiments, since an ammonia gas storage unit is connected to a supply tank, an ammonia component in a plating liquid stored in the supply tank can be suppressed from being volatilized outward and can be dissolved in the plating liquid. Thus, a concentration of the ammonia component in the plating liquid can be maintained within a preset target range, and degradation of the plating liquid can be suppressed.

### BRIEF DESCRIPTION OF THE DRAWINGS

FIG. 1 is a plane view illustrating a schematic configuration of a plating system in accordance with a first example embodiment.

FIG. 2 is a side view illustrating a plating apparatus in accordance with the first example embodiment.

FIG. 3 is a plane view of the plating apparatus shown in FIG. 2.

FIG. 4 is a diagram illustrating a liquid supplying device in accordance with the first example embodiment.

FIG. 5 is a schematic diagram illustrating the plating apparatus in accordance with the first example embodiment.

FIG. 6 is a schematic diagram illustrating the liquid supplying device in accordance with the first example embodiment.

FIG. 7 is a diagram illustrating a first heating device in accordance with the first example embodiment.

FIG. 8 is a diagram illustrating a second heating device in accordance with the first example embodiment.

FIG. 9 is a flowchart for describing a plating method.

FIG. 10 is a diagram illustrating a plating liquid collecting device in accordance with a second example embodiment.

FIG. 11 is a flowchart for describing processes in accordance with the second example embodiment in detail.

### DETAILED DESCRIPTION

### First Example Embodiment

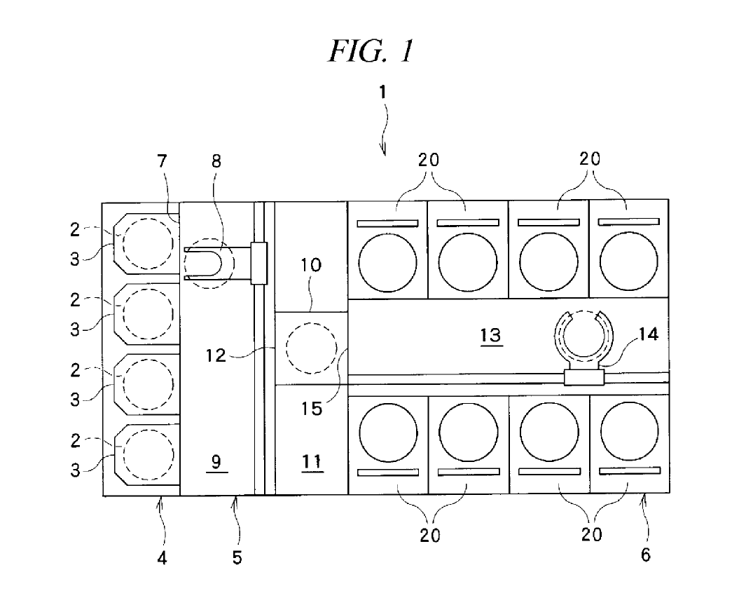

Hereinafter, a first example embodiment will be described with reference to FIG. 1 to FIG. 8. First, referring to FIG. 1, an overall plating system 1 in accordance with the first example embodiment will be elaborated.

(Plating System)

As depicted in FIG. 1, the plating system 1 includes a substrate loading/unloading chamber 5 and a substrate processing chamber 6. The substrate loading/unloading chamber 5 is configured to mount thereon a carrier 3 accommodating a multiple number (e.g., 25 sheets) of substrates 2 (herein, semiconductor wafers), and is configured to load and unload the substrates 2 by a preset number. The substrate processing chamber 6 is configured to perform various processes such as a plating process and a cleaning process on the substrates 2. The substrate loading/unloading chamber 5 and the substrate processing chamber 6 are arranged adjacent to each other.

(Substrate Loading/Unloading Chamber)

The substrate loading/unloading chamber 5 includes a carrier mounting unit 4; a transfer chamber 9 accommodating therein a transfer device 8; and a substrate transit chamber 11 accommodating therein a substrate transit table 10. Within the substrate loading/unloading chamber 5, the transfer chamber 9 and the substrate transit chamber 11 are connected to and communicate with each other via a transit opening 12. The carrier mounting unit 4 mounts thereon a multiple number of carriers 3, and each of the carriers 3 accommodates therein a multiple number of substrates 2 while holding the substrates 2 horizontally. In the transfer chamber 9, the substrates 2 are transferred, and in the substrate transit chamber 11, the substrates 2 are transited to and from the substrate processing chamber 6.

In this substrate loading/unloading chamber 5, the substrates 2 are transferred by the transfer device 8 between a single carrier 3 mounted on the carrier mounting unit 4 and the substrate transit table 10 by a preset number.

(Substrate Processing Chamber)

The substrate processing chamber 6 includes a substrate transfer unit 13 extended in a forward-backward direction at a central portion thereof; and a multiple number of plating apparatuses 20 arranged side by side in the forward-backward direction at two opposite sides of the substrate transfer unit 13 and configured to perform a plating process by supplying a plating liquid onto the substrates 2.

The substrate transfer unit 13 includes a substrate transfer device 14 configured to be movable in the forward-backward direction. Further, the substrate transfer unit 13 communicates with the substrate transit table 10 of substrate transit chamber 11 via a substrate loading/unloading opening 15.

In this substrate processing chamber 6, the substrates 2 are transferred into each of the plating apparatuses 20 one by one by the substrate transfer device 14 of the substrate transfer unit 13 while held on the substrate transfer device 14 horizontally. Further, in each of the plating apparatuses 20, a cleaning process and a plating process are performed on the substrates 2 one by one.

Except that the respective plating apparatuses 20 use different kinds of plating liquids, the respective plating apparatuses 20 have substantially the same configuration. Thus, hereinafter, a configuration of a single plating apparatus 20 among the multiple number of plating apparatuses 20 will be explained on behalf of the others.

(Plating Apparatus)

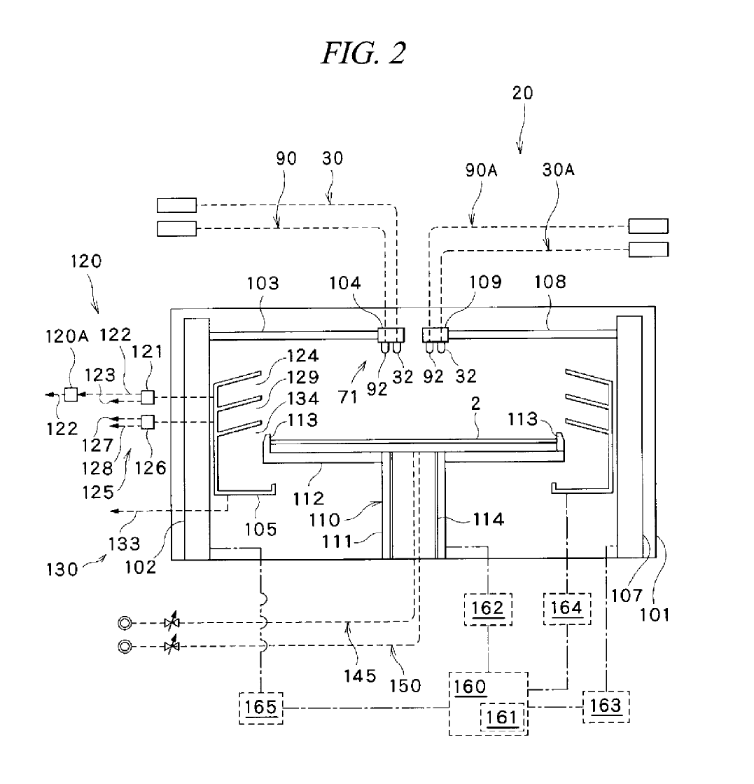

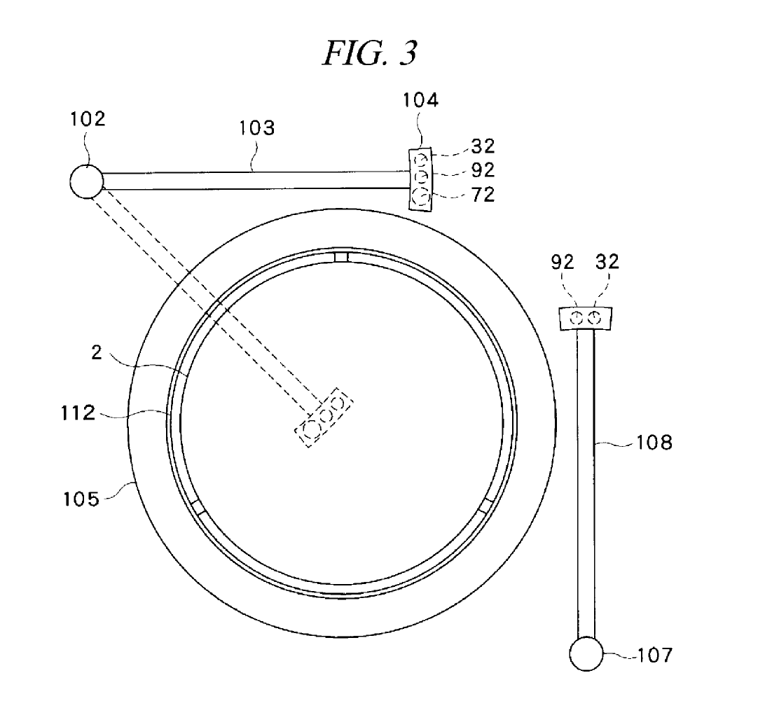

Below, referring to FIG. 2 and FIG. 3, the plating apparatus 20 will be described. FIG. 2 and FIG. 3 are a side view and a plane view illustrating the plating apparatus 20, respectively.

The plating apparatus 20 includes, as illustrated in FIG. 2 and FIG. 3, a substrate holding/rotating device (substrate accommodating unit) 110 configured to hold and rotate a substrate 2 within a casing 101; liquid supplying devices 30, 30A, 90 and 90A configured to supply a plating liquid, a cleaning liquid or the like onto the surface of the substrate 2; a cup 105 configured to receive the plating liquid or the cleaning liquid dispersed from the substrate 2; discharge openings 124, 129 and 134 through which the plating liquid, the cleaning liquid or the like received in the cup 105 is discharged; liquid draining devices 120, 125 and 130 configured to drain the plating liquid, the cleaning liquid or the like collected in the discharge openings; and a controller 160 configured to control the substrate holding/rotating device 110, the liquid supplying devices 30, 30A, 90 and 90A, the cup 105, and the liquid draining devices 120, 125 and 130.

(Substrate Holding/Rotating Device)

The substrate holding/rotating device 110 includes, as illustrated in FIG. 2 and FIG. 3, a hollow cylindrical rotation shaft 111 vertically extended within the casing 101; a turntable 112 provided at an upper end portion of the rotation shaft 111; a wafer chuck 113 disposed on a peripheral portion of a top surface of the turntable 112 to support the substrate 2; and a rotating device 162 configured to rotate the rotation shaft 111. The rotating device 162 is controlled by the controller 160, and the rotation shaft 111 is rotated by the rotating device 162. As a result, the substrate 2 supported on the wafer chuck 113 is rotated.

(Liquid Supplying Device)

Now, the liquid supplying devices 30, 30A, 90 and 90A configured to supply a plating liquid, a cleaning liquid, or the like onto the surface of the substrate 2 will be explained with reference to FIG. 2 to FIG. 6. The liquid supplying device 30 is a plating liquid supplying device configured to supply a plating liquid for a plating process onto the surface of the substrate 2. The liquid supplying device 90 is a cleaning liquid supplying device configured to supply a cleaning liquid for a post-cleaning process onto the surface of the substrate 2. The liquid supplying device 30A is a pre-plating liquid supplying device configured to supply a plating liquid for a pre-plating process onto the surface of the substrate 2. The liquid supplying device 90A is a cleaning liquid supplying device configured to supply a cleaning liquid for pre-cleaning onto the surface of the substrate 2.

Among these liquid supplying devices, the plating liquid supplying device 30 supplies a plating liquid containing Ni metal ions and an ammonia component that forms a complex of the Ni metal ions, or a plating liquid containing Co metal ions and an ammonia component that forms a complex of the Co metal ions. Further, the pre-plating liquid supplying device 30A supplies a plating liquid containing Pd metal ions.

(Plating Liquid Supplying Device 30)

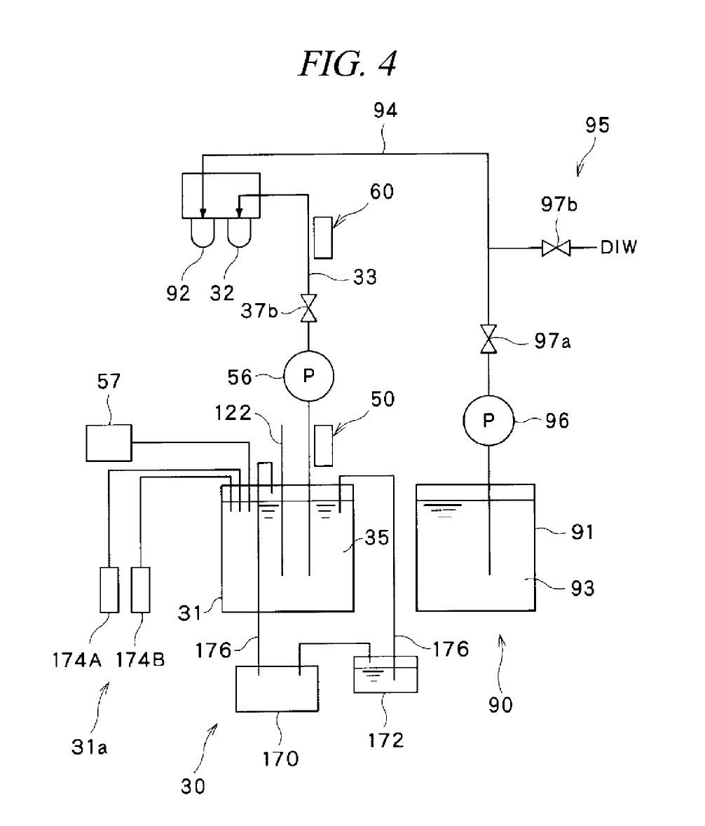

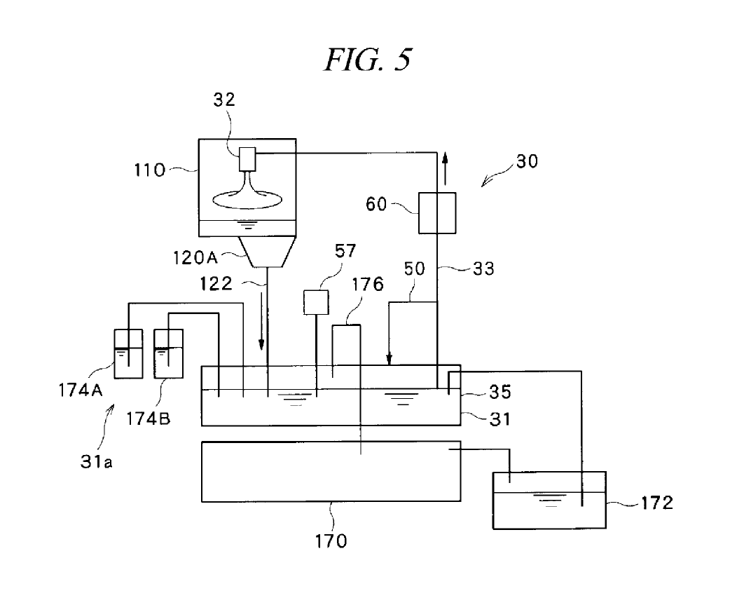

Now, referring to FIG. 4 and FIG. 5, the plating liquid supplying device 30 will be elaborated.

FIG. 5 is a schematic diagram illustrating only the plating liquid supplying device 30, and in FIG. 5, illustration of the pre-plating liquid supplying device 30A and the cleaning liquid supplying devices 90 and 90A is omitted for the simplicity of illustration.

As shown in FIG. 4 and FIG. 5, the plating liquid supplying device 30 includes a hermetically sealed supply tank 31, a discharge nozzle 32 and a plating liquid supplying line 33. The supply tank 31 stores therein a plating liquid 35 to be supplied to the substrate 2 at a preset temperature. The discharge nozzle 32 discharges the plating liquid 35 onto the substrate 2. The plating liquid 35 of the supply tank 31 is supplied to the discharge nozzle 32 through the plating liquid supplying line 33. Further, as depicted in FIG. 4, a valve 37b that can be opened and closed is provided at the plating liquid supplying line 33.

In the present example embodiment, a ‘preset temperature’ of the plating liquid supplied onto the substrate 2 is set to be equal to or higher than a plating temperature at which a self-reaction progresses within the plating liquid 35. The plating temperature will be elaborated later.

Various kinds of liquids are supplied into the supply tank 31 via a supplementing unit 31a from a multiple number of supplying sources in which various components, such as Ni, of the plating liquid 35 are stored. By way of non-limiting example, the liquids such as NiP metal salt containing Ni ions, a reducing agent, an additive, ammonia water and pure water are supplied in the supply tank 31.

In FIG. 4 and FIG. 5, only an ammonia water supplying unit 174A configured to supplement the supply tank 31 with ammonia water and a pure water supplying unit 174B configured to supplement the supply tank 31 with pure water are illustrated.

Further, a monitoring unit 57 configured to monitor characteristics of the plating liquid 35 may be provided at the supply tank 31. The monitoring unit 57 may serve as an ammonia concentration meter configured to measure ammonia concentration in the plating liquid 35, a pH meter and a temperature meter. Based on signals from the monitoring unit 57, flow rates of the various kinds of liquids supplied into the supply tank 31 are controlled by the controller 160, so that components of the plating liquid 35 stored in the supply tank 31 may be appropriately adjusted. By way of example, based on a signal from the monitoring unit 57, by the controller 160, ammonia water is supplied into the supply tank 31 from the ammonia water supplying unit 174A or pure water is supplied into the supply tank 31 from the pure water supplying unit 174B. As a result, an ammonia component and a pH value of the plating liquid 35 stored in the supply tank 31 are adjusted.

As depicted in FIG. 4 and FIG. 5, the supply tank 31 of the plating liquid supplying device 30 is hermetically sealed, and an ammonia gas storage unit 170 is connected to the supply tank 31 by a connection line 176. The ammonia gas storage unit 170 is configured to store therein ammonia water and is filled with an ammonia gas. The ammonia gas storage unit 170 is hermetically sealed and has a structure in which a volume thereof can be changed. The ammonia gas storage unit 170 supplies an ammonia gas into a space above a liquid surface of the plating liquid 35 within the supply tank 31. Since the ammonia gas storage unit 170 is capable of changing the volume thereof, a pressure within the ammonia gas storage unit 170 may be equilibrium with a pressure within the space above the liquid surface of the plating liquid 35. Even when a volume of the space above the liquid surface of the plating liquid 35 is changed due to a variation in an amount of the plating liquid within the supply tank 31, an appropriate amount of ammonia gas can be supplied to follow up the volume change.

Accordingly, since the plating liquid 35 stored in the supply tank 31 can be exposed to the ammonia gas, it is possible to maintain a concentration of the ammonia component within the plating liquid within a preset target range, and also possible to suppress the plating liquid from being degrade. Therefore, it is possible to supply the plating liquid 35, which is collected into the supply tank 31 of the plating liquid supplying device 30 from the substrate accommodating unit 110 via the liquid draining device 120, onto the substrate 2 through the discharge nozzle 32. As a result, the plating liquid 35 can be reused multiple times.

The discharge nozzle 32 is provided at a nozzle head 104. The nozzle head 104 is provided at a leading end portion of an arm 103. The arm 103 is configured to be extendable in a vertical direction and is provided at a supporting shaft 102 rotated by a rotating device 165. The plating liquid supply line 33 of the plating liquid supplying device 30 is provided within the arm 103. With this configuration, the plating liquid can be discharged onto a target position on the surface of the substrate 2 through the discharge nozzle 32 from a required supply height.

Further, as illustrated in FIG. 4, a first heating device 50 configured to heat the plating liquid 35 to a first temperature is provided at either one of the supply tank 31 and the plating liquid supplying line 33 of the plating liquid supplying device 30. Further, a second heating device 60 configured to heat the plating liquid 35 to a second temperature higher than the first temperature is provided at the plating liquid supplying line 33 between the first heating device 50 and the discharge nozzle 32. The first heating device 50 and the second heating device 60 will be elaborated later in detail.

A supplementing tank 172 is connected to the supply tank 31. The supplementing tank 172 is configured to store therein an unused plating liquid 35 and supply the unused plating liquid 35 into the supply tank 31 to supplement the supply tank 31 after the plating liquid in the supply tank 31 is consumed during a plating process. The ammonia gas storage unit 170 is also connected to the supplementing tank 172, and the plating liquid 35 stored in the supplementing tank 172 is exposed to the ammonia gas. Accordingly, a concentration of an ammonia component in the plating liquid 35 stored in the supplementing tank 172 can be maintained within a target range.

(Pre-Plating Liquid Supplying Device 30A)

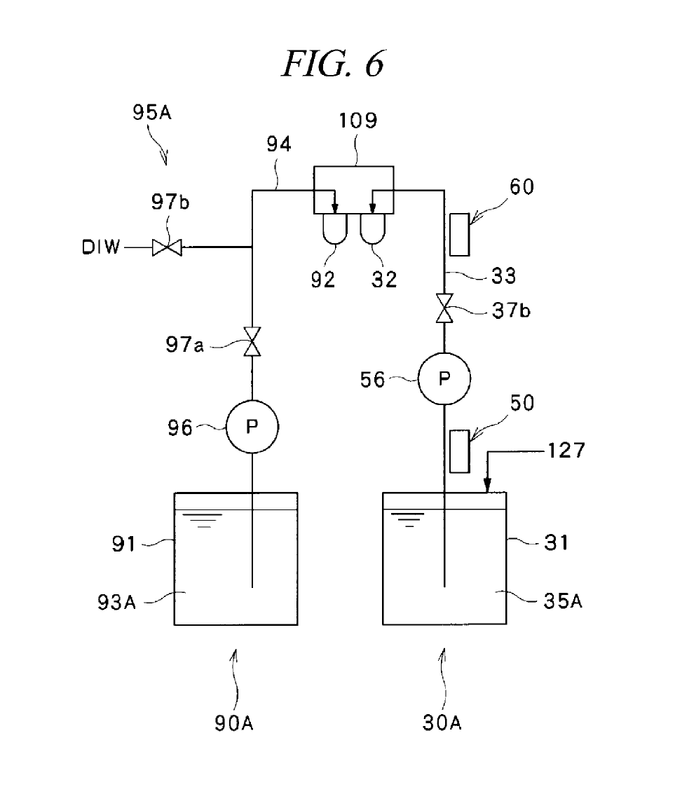

As depicted in FIG. 6, the pre-plating liquid supplying device 30A is configured to supply, onto the substrate 2, a plating liquid for performing a pre-plating process. Except that a different plating liquid 35A is used, the constituent components of the pre-plating liquid supplying device 30A configured to supply a plating liquid to the discharge nozzle 32 are substantially the same as those of the plating liquid supplying device 30. As shown in FIG. 2, the discharge nozzle 32 configured to discharge a Pd-containing plating liquid onto the surface of the substrate 2 is provided at a nozzle head 109. The nozzle head 109 is provided at a leading end portion of an arm 108. The arm 108 is configured to be extendable in a vertical direction and is provided at a supporting shaft 107 rotated by a rotating device 163. With this configuration, the plating liquid can be discharged onto a target position on the surface of the substrate 2 through the discharge nozzle 32 from a required supply height.

In the pre-plating liquid supplying device 30A shown in FIG. 6, the same parts as those of the plating liquid supplying device 30 will be assigned the same reference numerals, and detailed description thereof will be omitted.

(Cleaning Liquid Supplying Device 90)

The cleaning liquid supplying device 90 is used in performing a post-cleaning process on the substrate 2 as will be described later. As shown in FIG. 2, the cleaning liquid supplying device 90 includes a nozzle 92 provided at the nozzle head 104. Further, as illustrated in FIG. 4, the cleaning liquid supplying device 90 further includes a tank 91 configured to store therein a cleaning liquid 93 to be supplied to the substrate 2; a supplying line 94 through which the cleaning liquid 93 of a tank 91 is supplied to the nozzle 92; and a pump 96 and a valve 97a provided at the supplying line 94. Further, as depicted in FIG. 4, the supplying line 94 and the nozzle 92 may be shared between the cleaning liquid supplying device 90 and a rinse liquid supplying device 95 configured to supply a rinse liquid such as pure water onto the surface of the substrate 2. In such a configuration, by controlling the opening and closing of the valve 97a and a valve 97b appropriately, either one of the cleaning liquid 93 and the rinse liquid may be selectively discharged onto the surface of the substrate 2 from the NOZZLE 92.

(Cleaning Liquid Supplying Device 90A)

The cleaning liquid supplying device 90A is used in performing a pre-cleaning process on the substrate 2 as will be described later. As illustrated in FIG. 2, the cleaning liquid supplying device 90A includes the nozzle 92 provided at the nozzle head 109. As illustrated in FIG. 6, except that a different cleaning liquid 93A is used, the constituent components of the cleaning liquid supplying device 90A are substantially the same as those of the cleaning liquid supplying device 90. In the cleaning liquid supplying device 90A shown in FIG. 6, the same parts as those of the cleaning liquid supplying device 90 will be assigned the same reference numerals, and detailed description thereof will be omitted.

(Liquid Draining Device)

Now, the liquid draining devices 120, 125 and 130 configured to drain the plating liquid or the cleaning liquid dispersed from the substrate 2 will be elaborated with reference to FIG. 2. As shown in FIG. 2, the cup 105 capable of being moved up and down by an elevating device 164 and having the discharge openings 124, 129 and 134 is disposed within the casing 101. The liquid draining devices 120, 125 and 130 are configured to drain the liquids collected in the discharge openings 124, 129 and 134, respectively.

The processing liquids supplied onto the substrate 2 may be drained by the liquid draining devices 120, 125 and 130 through the discharge openings 124, 129 and 134, respectively, while separated by their kinds. By way of example, the liquid draining device 120 is a plating liquid draining device configured to drain the plating liquid 35; the liquid draining device 125 is a plating liquid draining device configured to drain the plating liquid 35A; and the liquid draining device 130 is a processing liquid draining device 130 configured to drain the cleaning liquids 93 and 93A and the rinse liquid.

As shown in FIG. 2, the plating liquid draining device 120 (125) includes a collecting flow path 122 (127) and a waste flow path 123 (128), which are switched by a flow path switching device 121 (126). Here, the collecting flow paths 122 and 127 are configured to collect and reuse the plating liquids, while the waste flow paths 123 and 128 are configured to dispose of the plating liquids. Further, as shown in FIG. 2, the processing liquid draining device 130 has only a waste flow path 133.

As shown in FIG. 2 and FIG. 5, the collecting flow path 122 of the plating liquid draining device 120 configured to drain the plating liquid 35 is connected to an outlet side of the substrate accommodating unit 110. A cooling buffer 120A configured to cool the plating liquid 35 is provided at the collecting flow path 122 to be positioned near the outlet side of the substrate accommodating unit 110. The plating liquid 35 cooled by the cooling buffer 120A is returned back into the supply tank 31 through the collecting flow path 122.

Now, the first heating device 50 and the second heating device 60 provided in each of the plating liquid supplying device 30 and the pre-plating liquid supplying device 30A will be elaborated.

(First Heating Device)

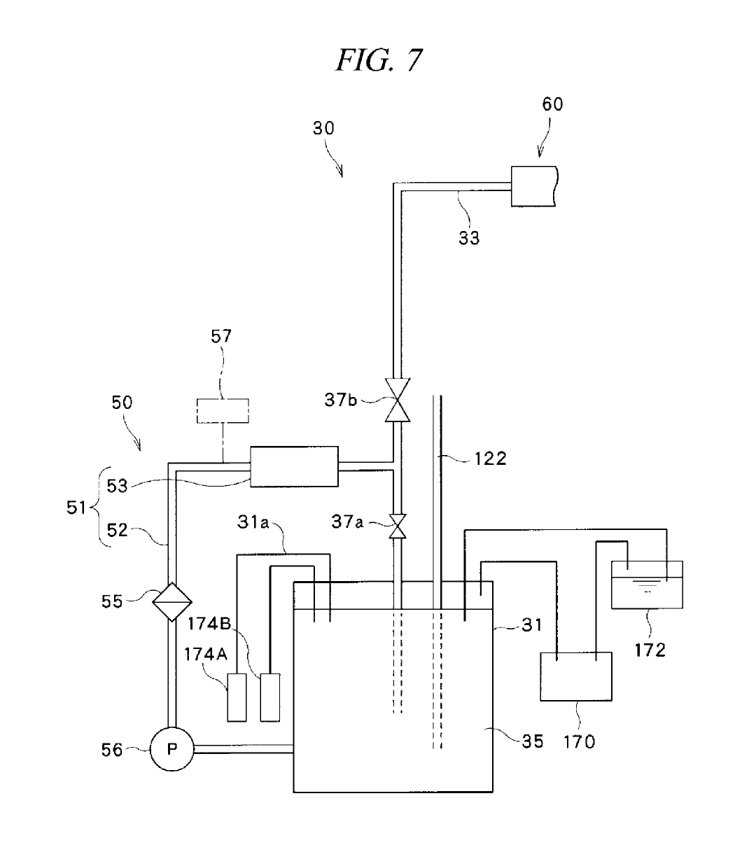

Now, the first heating device 50 will be described. FIG. 7 illustrates the first heating device 50 including a supply tank circulating/heating unit 51 that is configured to heat the plating liquid 35 to a first temperature. The first temperature is set to be a certain temperature higher than a room temperature and lower than a temperature (plating temperature) at which precipitation of metal ions progresses through self-reaction within the plating liquid 35. By way of example, as for the Ni-containing plating liquid 35, a plating temperature thereof is about 60° C. In such a case, the first temperature is set to be in the range from about 40° C. to about 60° C.

The supply tank circulating/heating unit 51 includes, as illustrated in FIG. 7, a supply tank circulating line 52 configured to circulate the plating liquid 35 in the vicinity of the supply tank 31; and a supply tank heater 53 provided at the supply tank circulating line 52 and configured to heat the plating liquid 35 to a first temperature. Further, as depicted in FIG. 7, a filter 55 and a pump 56 configured to circulate the plating liquid 35 are provided at the supply tank circulating line 52. By providing the supply tank circulating/heating unit 51 having this configuration, it is possible to heat the plating liquid 35 in the supply tank 31 to the first temperature while circulating the plating liquid 35 in the vicinity of the supply tank 31. Further, as shown in FIG. 7, the plating liquid supplying line 33 is connected to the supply tank circulating line 52. In this configuration, when a valve 37a shown in FIG. 7 is opened while the valve 37b is closed, the plating liquid 35 having passed through the supply tank heater 53 is returned back into the supply tank 31. Meanwhile, when the valve 37a is closed while the valve 37b is opened, the plating liquid 35 passing through the supply tank heater 53 reaches the second heating device 60 through the plating liquid supplying line 33.

Further, instead of providing the monitoring unit 57 at the supply tank 31, the monitoring unit 57 configured to monitor the characteristics of the plating liquid 35 may be provided at the supply tank circulating line 52 as indicated by a dashed dotted line in FIG. 7.

(Second Heating Device)

Now, referring to FIG. 8, the second heating device 60 will be elaborated. The second heating device 60 is configured to further heat the plating liquid 35, which is heated to the first temperature by the first heating device 50, to a second temperature. The second temperature is set to be equal to or higher than the plating temperature as described above. By way of example, the plating temperature of the plating liquid 35 containing Ni is about 60° C. as described above. In this case, the second temperature is set to be in the range from about 60° C. to about 90° C.

As illustrated in FIG. 8, the second heating device 60 includes a second temperature medium supplying unit 61 and a temperature controller 62. The second temperature medium supplying unit 61 is configured to heat a certain heat transfer medium to a second temperature or a temperature higher than the second temperature. The temperature controller 62 is provided at the plating liquid supplying line 33 between the first heating device 50 and the discharge nozzle 32 and is configured to transfer heat of the heat transfer medium from the second temperature medium supplying unit 61 to the plating liquid 35 within the plating liquid supplying line 33. Further, as illustrated in FIG. 8, the second heating device 60 may further include a temperature maintaining unit 65 provided at the arm 103 and configured to maintain the temperature of the plating liquid 35 passing through the plating liquid supplying line 33 located within the arm 103 at the second temperature. Further, in FIG. 8, a part of the plating liquid supplying line 33 located within the temperature controller 62 is indicated by a reference numeral 33a, while a part of the plating liquid supplying line 33 located within the temperature maintaining unit 65 (within the arm 103) is indicated by a reference numeral 33b.

(Temperature Controller 62)

The temperature controller 62 includes a supply opening 62a through which the heat transfer medium (e.g., hot water) for temperature control is introduced from the second temperature medium supplying unit 61; and a discharge opening 62b through which the heat transfer medium is discharged out. The heat transfer medium supplied through the supply opening 62a comes into contact with the plating liquid supplying line 33a while the heat transfer medium flows in a space 62c within the temperature controller 62. With this configuration, the plating liquid 35 flowing through the plating liquid supplying line 33a is heated to the second temperature. After used for heating the plating liquid 35, the heat transfer medium is discharged out through the discharge opening 62b.

(Temperature Maintaining Unit 65)

The temperature maintaining unit 65 provided between the temperature controller 62 and the discharge nozzle 32 is configured to maintain, before the plating liquid 35 is discharged from the discharge nozzle 32, the temperature of the plating liquid 35 heated to the second temperature by the temperature controller 62. The temperature maintaining unit 65 includes, as shown in FIG. 8, a heat insulation pipe 65c extended to be in contact with the plating liquid supplying line 33b within the temperature maintaining unit 65; a supply opening 65a through which the heat transfer medium supplied from the second temperature medium supplying unit 61 is introduced into the heat insulation pipe 65c; and a discharge opening 65b through which the heat transfer medium is discharged. The heat insulation pipe 65c is extended to the close vicinity of the discharge nozzle 32 along the plating liquid supplying line 33b. With this configuration, the temperature of the plating liquid 35 immediately before the plating liquid 35 is discharged from the discharge nozzle 32 can be maintained at the second temperature.

As shown in FIG. 8, the heat insulation pipe 65c may be opened within the nozzle head 104 accommodating therein the discharge nozzle 32, while communicating with a space 65d within the temperature maintaining unit 65. In this configuration, the temperature maintaining unit 65 may have a triple structure (triple-pipe structure) including the plating liquid supplying line 33b located at a central portion of a cross section thereof; the heat insulation pipe 65c surrounding the plating liquid supplying line 33b to be thermally in contact with the plating liquid supplying line 33b; and a space 65d surrounding the heat insulation pipe 65c. The heat transfer medium introduced through the supply opening 65a serves to maintain the temperature of the plating liquid 35 through the heat insulation pipe 65c until the heat transfer medium reaches the nozzle head 104. Then, the heat transfer medium is discharged from the discharge opening 65b after passing through the space 65d within temperature maintaining unit 65.

(Other Constituent Components)

As shown in FIG. 2, the plating apparatus 20 may further include a rear surface processing liquid supplying device 145 configured to supply a processing liquid to a rear surface of the substrate 2; and a rear surface gas supplying device 150 configured to supply a gas to the rear surface of the substrate 2.

The plating system 1 including a multiple number of plating apparatuses 20 having the above-described configuration is controlled by the controller 160 according to various kinds of programs recorded on a storage medium 161 provided in the controller 160. Therefore, various processes are performed on the substrate 2. Here, the storage medium 161 stores thereon various kinds of setup data or various kinds of programs such as a plating program to be described later. The storage medium may be implemented by a computer-readable memory such as a ROM or a RAM, or a disk-type storage medium such as a hard disk, a CD-ROM, DVD-ROM or a flexible disk, as commonly known in the art.

In accordance with the present example embodiment, the operations of the plating system 1 and the plating apparatus 20 are controlled to perform a plating process on the substrate 2 according to a plating program recorded on the storage medium 161. The following description will be provided for the case of using a plating liquid containing Ni ions as the plating liquid 35 for a plating process and using a plating liquid containing Pd ions as the plating liquid 35A for a pre-plating process.

First, a method of controlling a temperature of a Ni plating liquid used in the chemical reduction plating will be explained. Then, there will be also described a method of performing Ni plating by the chemical reduction plating after performing Pd plating on the substrate 2 by the displacement plating in the single plating apparatus 20, and then, performing Au plating on the substrate 2 by the displacement plating in another plating apparatus 20.

(Method of Controlling Temperature of Plating Liquid for Chemical Reduction Plating)

(First Temperature Control Process)

Now, a process for controlling the temperature of the plating liquid 35 to be discharged onto the surface of the substrate 2 will be elaborated. First, referring to FIG. 7, there will be explained a first temperature control process in which the plating liquid 35 to be discharged onto the surface of the substrate 2 is heated to the first temperature lower than a certain temperature when the plating liquid 35 is supplied onto the substrate and a plating process is performed on the substrate 2. First, the temperature of the supply tank heater 53 of the first heating device 50 is raised to the first temperature or a certain temperature higher than the first temperature. Then, while circulating the plating liquid 35 within the supply tank circulating line 52 by using the pump 56, the plating liquid 35 is heated to the first temperature. At this time, the valve 37a is opened and the valve 37b is closed. Through this process, the temperature of the plating liquid 35 stored in the supply tank 31 is controlled to the first temperature.

(Second Temperature Control Process)

Now, referring to FIG. 7 and FIG. 8, there will be described a second temperature control process for further heating the plating liquid 35 to a second temperature equal to or higher than the certain temperature when the plating liquid 35 is supplied to the substrate 2 and the plating process is performed. First, the valve 37a is closed and the valve 37b is opened. Accordingly, the plating liquid 35 controlled to the first temperature is supplied into the temperature controller 62 of the second heating device 60 through the plating liquid supplying line 33. In the temperature controller 62, a heat transfer medium heated to a temperature equal to or higher than the second temperature is supplied from the second temperature medium supplying unit 61. Accordingly, the plating liquid 35 is heated to the second temperature while the plating liquid 35 passes through the plating liquid supplying line 33a within the temperature controller 62

Thereafter, the plating liquid 35 heated to the second temperature is supplied into the discharge nozzle 32 through the arm 103, as illustrated in FIG. 8. Here, the temperature maintaining unit 65 is provided at the arm 103, and a heat transfer medium heated to the second temperature is supplied in the temperature maintaining unit 65 from the second temperature medium supplying unit 61. Accordingly, the plating liquid 35 can be maintained at the second temperature until the plating liquid 35 reaches the discharge nozzle 32 through the plating liquid supplying line 33b within the temperature maintaining unit 65.

(Plating Method)

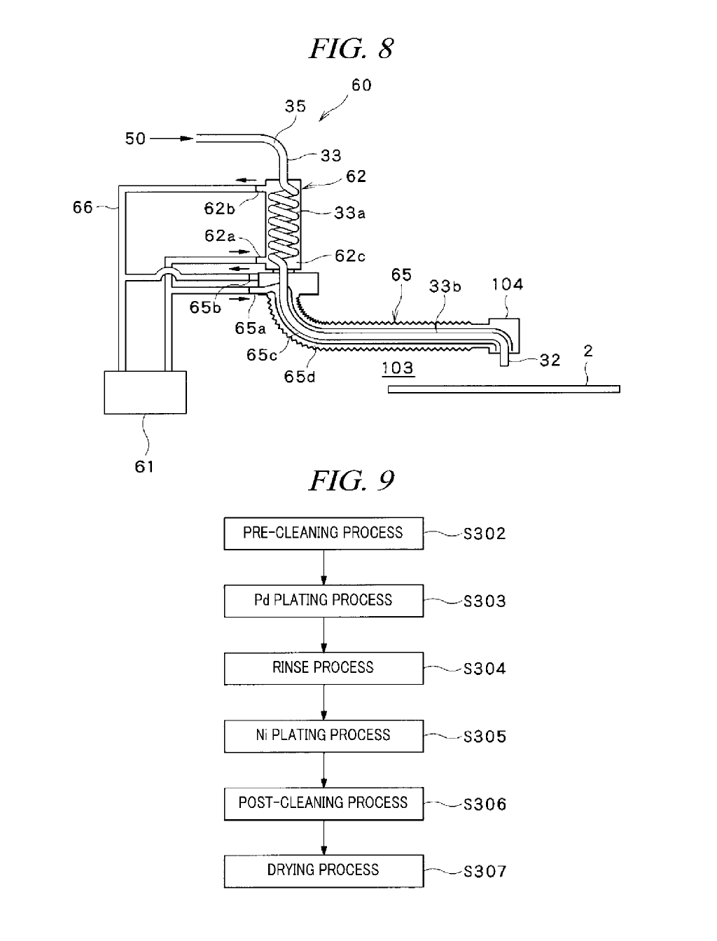

Now, a method of performing Pd plating on the substrate 2 by the displacement plating (i.e., a pre-plating process) and then performing Ni plating by the chemical reduction plating with the Ni plating liquid as prepared as described above (i.e., a plating process) in a single plating apparatus 20 will be discussed with reference to FIG. 9.

(Substrate Loading Process and Substrate Receiving Process)

First, a substrate loading process and a substrate receiving process are performed. A single sheet of substrate 2 is loaded into the one plating apparatus 20 from the substrate transit chamber 11 by the substrate transfer device 14 of the substrate transfer unit 13. In the plating apparatus 20, the cup 105 is lowered to a preset position, and the loaded substrate 2 is held by the wafer chuck 113. Then, the cup 105 is raised by the elevating device 164 up to a position where an outer peripheral end portion of the substrate 2 faces the discharge opening 134.

(Pre-Cleaning Process)

Thereafter, a pre-cleaning process (block S302) including a rinse process, a pre-cleaning process and another rinse process is performed. First, the valve 97b of the rinse liquid supplying device 95A is opened, and then, a rinse liquid is supplied onto the surface of the substrate 2 via the nozzle 92. Then, a pre-cleaning process is performed. The valve 97b of the rinse liquid supplying device 95A is closed, and the valve 97a of the cleaning liquid supplying device 90A is opened. Then, the cleaning liquid 93A is supplied onto the surface of the substrate 2 via the nozzle 92. Thereafter, the rinse liquid is also supplied onto the surface of the substrate 2 via the nozzle 92 in the same manner as described above, and another rinse process is performed. The used rinse liquid and the used cleaning liquid 93A are disposed of through the discharge opening 134 of the cup 105 and the waste flow path 133 of the processing liquid draining device 130. Upon the completion of the pre-cleaning process on the surface of the substrate 2, the valve 97a is closed.

(Pd Plating Process)

Subsequently, a Pd plating process (pre-plating process) (block S303) is performed. This Pd plating process is performed as a displacement plating process while the substrate 2 is not yet dried after the pre-cleaning process is completed.

In the Pd plating process, the cup 105 is lowered by the elevating device 164 up to a position where the discharge opening 129 and the outer peripheral end portion of the substrate 2 face each other. Then, the valve 37b of the plating liquid supplying device 30A is opened, and then, the Pd-containing plating liquid 35A stored in the supply tank 31 is discharged onto the surface of the substrate 2 through the discharge nozzle 32 at a desired flow rate. As a result, Pd plating is performed on the surface of the substrate 2 by displacement plating. The used plating liquid 35A is drained out through the discharge opening 129 of the cup 105. Thereafter, the used plating liquid 35A is collected into the supply tank 31 through the collecting flow path 127 or disposed of through the waste flow path 128. Upon the completion of the Pd plating on the surface of the substrate 2, the valve 37b is closed.

(Rinse Process)

Thereafter, a rinse process (block S304) is performed. Since the rinse process (block S304) is substantially the same as the rinse process in the cleaning process (block S302) as described above, detailed description thereof will be omitted.

(Ni Plating Process)

Then, a Ni plating process (plating process) (block S305) is performed in the same plating apparatus 20 as used in performing the above-described processes (blocks S302 to S304). This Ni plating process is performed as a chemical reduction plating process.

In the Ni plating process (block S305), the cup 105 is lowered by the elevating device 164 to a position where the discharge opening 124 and the outer peripheral end portion of the substrate 2 face each other. Then, the plating liquid 35 heated to the first temperature by the first heating device 50 and further heated to the second temperature by the second heating device 60 is discharged from the discharge nozzle 32 at a required flow rate. As a result, Ni plating process is performed on the surface of the substrate 2 by the chemical reduction plating. The used plating liquid 35 is discharged through the discharge opening 124 of the cup 105. Then, the used plating liquid 35 is collected into the supply tank 31 through the collecting flow path 122 or disposed of through the waste flow path 123.

By performing the Ni plating process, a flow rate of the used plating liquid 35 discharged through the discharge opening 124 is smaller than that of the plating liquid 35 discharged from the discharge nozzle 32. Further, since the plating liquid 35 is heated to the second temperature, an ammonia component may volatilize easily from the plating liquid 35. Thus, a great amount of ammonia component is removed from the plating liquid 35 within the plating apparatus 20.

(Post-Cleaning Process)

Subsequently, a post-cleaning process (block S306) including a rinse process, a post-cleaning process and another rinse process is performed.

First, the cup 105 is raised by the elevating device 164 up to the position where the discharge opening 134 and the outer peripheral end portion of the substrate 2 face each other. Then, a rinse process is performed on the surface of the substrate 2 on which the Ni plating process has been performed. The valve 97b of the rinse liquid supplying device 95 is opened, and a rinse liquid is supplied onto the surface of the substrate 2 through the nozzle 92.

Subsequently, a post-cleaning process is performed. First, the valve 97b of the rinse liquid supplying device 95 is closed, and the valve 97a of the cleaning liquid supplying device 90 is opened. Then, the cleaning liquid 93 is supplied onto the surface of the substrate 2 through the nozzle 92. Thereafter, the rinse liquid is supplied onto the surface of the substrate 2 through the nozzle 92 in the same manner as described above, and another rinse process is performed. The used rinse liquid or the used cleaning liquid 93 is disposed of through the discharge opening 134 of the cup 105 and the waste flow path 133 of the processing liquid draining device 130. Upon the completion of the post-cleaning process on the surface of the substrate 2, the valve 97b is closed.

(Drying Process)

Subsequently, a drying process (block S307) for drying the substrate 2 is performed. By way of example, by rotating the turntable 112, the liquid adhering to the substrate 2 may be dispersed outward by a centrifugal force, so that the substrate 2 may be dried. That is, the turntable 112 may serve as a drying device configured to dry the surface of the substrate 2.

As discussed above, in the single plating apparatus 20, the Pd plating is first performed on the surface of the substrate 2 by displacement plating, and the Ni plating is then performed by chemical reduction plating.

Thereafter, the substrate 2 is transferred into another plating apparatus 20 for Au plating. In this another plating apparatus 20, an Au plating process is performed on the surface of the substrate 2 by displacement plating. Except that a plating liquid and a cleaning liquid different from those of the Pd plating process are used, the method of the Au plating is substantially the same as that of the Pd plating process as described above. Thus, detailed description thereof will be omitted here.

(Method for Collecting and Reusing Plating Liquid)

Now, a method for collecting and reusing the plating liquid used in the above-described Ni plating process will be explained.

(Cooling Process)

First, the flow path switching device 121 is switched to allow the used plating liquid discharged through the discharge opening 124 of the cup 105 to flow into the collecting flow path 122. The plating liquid flown into the collecting flow path 122 is then introduced into the cooling buffer 120A while maintaining a relatively high temperature close to the second temperature set when the plating process is performed. Here, the plating liquid is cooled to a temperature lower than the plating temperature by a cooling device provided at the cooling buffer 120A. Accordingly, precipitation of metal ions through self-reaction within the plating liquid is suppressed, and degradation of the plating liquid can be suppressed. Further, since volatilization of the ammonia component can be suppressed, it may be possible to suppress the ammonia component from being reduced from the plating liquid 35 at a downstream side of the cooling buffer 120A.

(Composition Adjusting Process)

Then, the plating liquid cooled by the cooling buffer 120A is returned back into the supply tank 31. In the supply tank 31, an ammonia concentration, a pH value and a temperature of the plating liquid 35 are measured by the monitoring unit 57 provided at the supply tank 31. Then, a signal from the monitoring unit 57 is sent to the controller 160. When there is a shortage of the ammonia component, ammonia water is supplied into the supply tank 31 from the ammonia water supplying unit 174A under the control of the controller 160. When there is a shortage of pure water, the pure water is supplied into the supply tank 31 from the pure water supplying unit 174B under the control of the controller 160. Further, when the plating liquid 35 is supplied in an amount corresponding to the consumption amount during the plating process or there is a shortage of the plating liquid 35 in the supply tank 31, the supply tank 31 is supplemented with the unused plating liquid 35 from the supplementing tank 172. Further, since the ammonia gas storage unit 170 is connected to the supply tank 31, the space within the supply tank 31 is filled with an ammonia gas supplied from the ammonia gas storage unit 170. Since the plating liquid 35 within the supply tank 31 is exposed to the ammonia gas, it is possible to suppress the ammonia component of the plating liquid 35 from being volatilized, and also possible to dissolve the ammonia component in the plating liquid 35.

Through this process, the ammonia component and the pH value of the used plating liquid 35 can be appropriately adjusted. Thus, the concentration of the ammonia component within the plating liquid can be maintained within the preset target range, and degradation of the plating liquid can be suppressed. Then, the used plating liquid may be supplied again onto the substrate 2 through the discharge nozzle 32. Therefore, the plating liquid can be reused multiple times.

(Effect of First Example Embodiment)

In accordance with the present example embodiment, since the ammonia gas storage unit 170 is connected to the supply tank 31, the plating liquid 35 stored in the supply tank 31 is exposed to the ammonia gas. Thus, it is possible to suppress the ammonia component from being volatilized from the plating liquid, and also possible to dissolve the ammonia component in the plating liquid. Accordingly, the concentration of the ammonia component within the plating liquid can be maintained within the preset target range, and degradation of the plating liquid can be suppressed. Therefore, it is possible to supply the plating liquid, which is returned back into the supply tank 31 from the substrate accommodating unit 110, onto the substrate 2 through the discharge nozzle 32, again. Therefore, the plating liquid can be reused multiple times.

Further, when there is a shortage of the plating liquid 35 within the supply tank 31, the unused plating liquid 35 is supplied into the supply tank 31 from the supplementing tank 172. In this case, since the ammonia gas storage unit 170 is also connected to the supplementing tank 172, it may be also possible to maintain a concentration of an ammonia component of the unused plating liquid 35 stored in the supplementing tank 172 within the preset target range.

Moreover, the concentration of the ammonia component, the pH value and the temperature of the plating liquid 35 are measured by the monitoring unit 57 provided at the supply tank 31. Then, a signal is sent from the monitoring unit 57 to the controller 160, and the supply tank 31 is supplemented with ammonia water or pure water under the control of the controller 160. Therefore, the ammonia component and the pH value of the plating liquid 35 stored in the supply tank 31 can be adjusted.

Furthermore, in accordance with the present example embodiment, as described above, there are provided the first heating device 50 configured to heat the plating liquid 35 to the first temperature and the second heating device 60 configured to further heat the plating liquid 35 to the second temperature. That is, the plating liquid 35 is heated up to the second temperature through two stages. Accordingly, a time period during which the plating liquid 35 is maintained at the second temperature can be shortened, so that the lifetime of the plating liquid 35 can be increased. Further, generation of particles through self-reaction of the plating liquid can also be suppressed.

### Other Modification Examples

Further, in the present example embodiment, the plating liquid 35 containing Ni is plated on the surface of the substrate 2 by chemical reduction plating in the plating apparatus 20. However, the example embodiment may not be limited thereto, and various other types of plating liquids may be plated on the surface of the substrate 2 by chemical reduction plating in the plating apparatus 20. By way of non-limiting example, a plating liquid containing Co (such as CoWB, CoWP, CoB, CoP, or the like) may be plated on the surface of the substrate 2 by chemical reduction plating. Even in a case that these plating liquids are used, the two-stage heating of the plating liquid 35 by the first heating device 50 and the second heating device 60 may be performed. In this case, specific values of the first temperature and the second temperature may be appropriately determined depending on a plating temperature of the plating liquid. For example, when CoP plating liquid is used as the plating liquid 35, a plating temperature thereof is in the range of about 50° C. to about 70° C., and the first temperature may be set to be in the range of, e.g., about 40° C. to the plating temperature, and the second temperature may be set to be in the range of, e.g., the plating temperature to about 90° C.

Furthermore, in the present example embodiment, the first heating device 50 and the second heating device 60 may also be provided at the plating liquid supplying device 30A, as in the case of the plating liquid supplying device 30. Moreover, the two-stage heating by the first heating device 50 and the second heating device 60 may also be performed for the plating liquid 35A containing Pd. Further, if the plating liquid 35A includes an ammonia component, the supplementing tank 172 storing therein the unused plating liquid may be connected to the supply tank 31 of the plating liquid supplying device 30A, and the ammonia gas storage unit 170 may be connected to the supply tank 31 and the supplementing tank 172. Further, the ammonia water supplying unit 174A and the pure water supplying unit 174B may be connected to the supply tank 31A. Accordingly, ammonia water from the ammonia water supplying unit 174A or pure water from the pure water supplying unit 174B may be supplied into the supply tank 31 based on a signal from the monitoring unit 57 provided at the supply tank 31A.

In addition, the above example embodiment has been described for the case of performing Pd plating on the substrate 2 by the displacement plating, and then, performing Ni plating by the chemical reduction plating in the single plating apparatus 20 (blocks S302 to S309 of FIG. 9). However, the example embodiment may not be limited thereto, and only chemical reduction plating may be performed as a plating process in the single plating apparatus 20. In such a case, among the processes shown in FIG. 9, the processes other than blocks S303 and S304 may be performed. At this time, a plating liquid for the chemical reduction plating may not be particularly limited, and various plating liquids such as CoWB, CoWP, CoB, CoP and NiP for chemical reduction plating may be used.

### Second Example Embodiment

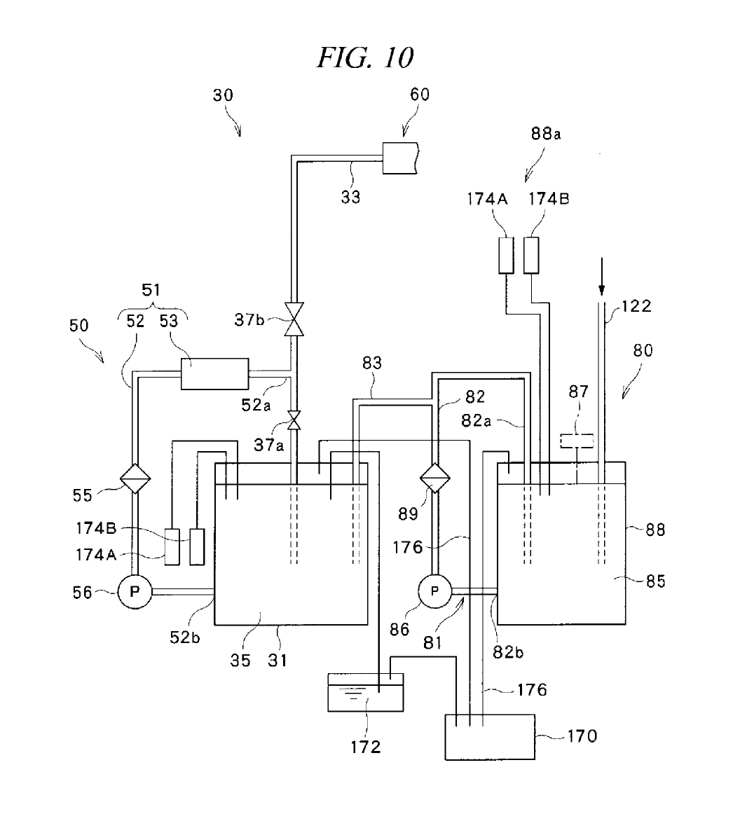

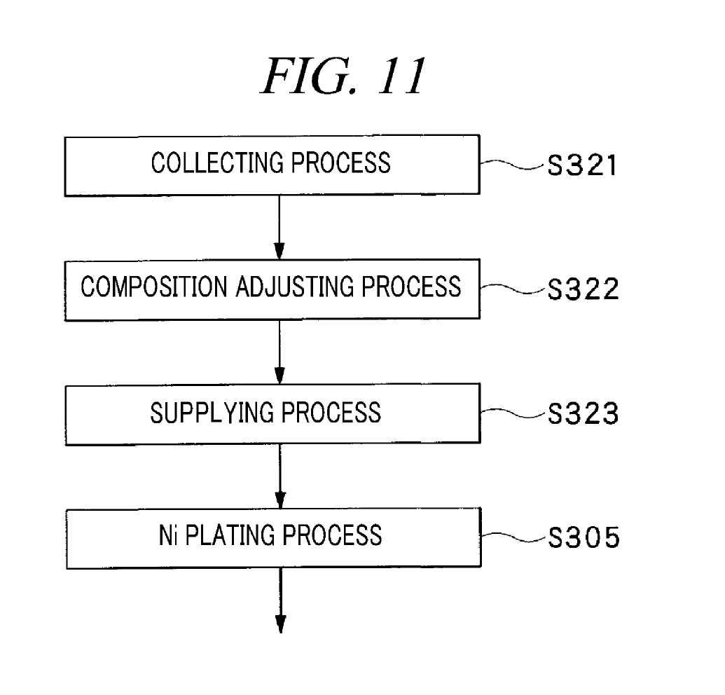

Now, referring to FIG. 10 and FIG. 11, a second example embodiment will be described. Except that a plating liquid supplying device further includes a plating liquid collecting device configured to adjust a composition of a plating liquid drained from a plating liquid draining device and configured to supply the composition-adjusted plating liquid into a supply tank of a plating liquid supplying device, a configuration of the second example embodiment shown in FIG. 10 and FIG. 11 is substantially the same as that of the first example embodiment shown in FIG. 1 to FIG. 5. In the second example embodiment shown in FIG. 10 and FIG. 11, the same parts as those of the first example embodiment shown in FIG. 1 to FIG. 5 will be assigned same reference numerals, and detailed description thereof will be omitted.

In accordance with the second example embodiment, a used plating liquid containing Ni collected through the collecting flow path 122 of the plating liquid draining device 120 is reused. Below, referring to FIG. 10, a plating liquid collecting device 80 configured to reuse the used plating liquid will be explained.

(Plating Liquid Collecting Device)

As shown in FIG. 10, the plating liquid collecting device 80 includes a collecting tank 88 configured to store a used plating liquid 85 drained from the plating liquid draining device 120. Like the supply tank 31, the collecting tank 88 is hermetically sealed, and the ammonia gas storage unit 170 is connected to the supply tank 31 and the collecting tank 88 by the connection line 176. The ammonia gas storage unit 170 supplies an ammonia gas into a space above a liquid surface of the plating liquid 35 within the collecting tank 88.

Further, the plating liquid collecting device 80 may further include a supplementing unit 88a configured to add component deficient in the used plating liquid 85 stored in the collecting tank 88; and an agitating unit 81 configured to agitate the plating liquid 85 stored in the collecting tank 88. The supplementing unit 88a is configured to add liquids such as a NiP metal salt containing Ni, a reducing agent, an additive, ammonia water and pure water to the plating liquid 85 within the collecting tank 88, so that the composition of the plating liquid 85 is appropriately adjusted. By way of example, the ammonia water supplying unit 174A configured to supplement the collecting tank 88 with ammonia water and the pure water supplying unit 174B configured to supplement the collecting tank 88 with pure water are connected to the collecting tank 88.

In order to perform such composition adjustment more accurately, as indicated by a dashed dotted line in FIG. 10, a monitoring unit 87 configured to monitor characteristics of the plating liquid 85 may be provided at the collecting tank 88. The monitoring unit 87 may serve as an ammonia concentration meter, a pH meter and a temperature meter. Based on signals from the monitoring unit 87, flow rates of various kinds of liquids supplied by the supplementing unit 88a are controlled by the controller 160. By way of example, based on a signal from the monitoring unit 87, by the controller 160, ammonia water is supplied into the collecting tank 88 from the ammonia water supplying unit 174A or pure water is supplied into the collecting tank 88 from the pure water supplying unit 174B so that an ammonia component and a pH value of the plating liquid 85 stored in the collecting tank 88 are appropriately adjusted.

For example, as illustrated in FIG. 10, the agitating unit 81 may be configured to agitate the plating liquid 85 by circulating the plating liquid 85 in the vicinity of the collecting tank 88. The agitating unit 81 may include, as shown in FIG. 10, a collecting tank circulating line 82 of which both ends 82a and 82b are connected to the collecting tank 88; and a pump 86 and a filter 89 provided at the collecting tank circulating line 82. By providing the agitating unit 81 having this configuration, it may be possible to remove various impurities contained in the plating liquid while agitating the plating liquid 85. For example, it is possible to remove impurities (particles), which may serve as nuclei when metal ions are precipitated, from the plating liquid. Further, a connection line 83 through which the plating liquid 85 is supplied to the supply tank 31 is connected to the agitating unit 81.

In accordance with the present example embodiment, by connecting the ammonia gas storage unit 170 to the supply tank 31 and the collecting tank 88, the plating liquid 35 stored in the supply tank 31 and the collecting tank 88 can be exposed to an ammonia gas, so that a concentration of an ammonia component within the plating liquid 35 can be maintained within a preset target range, and degradation of the plating liquids can be suppressed.

Therefore, it is possible to supply the plating liquid 35, which is collected into the collecting tank 88 via the liquid draining device 120 from the substrate accommodating unit 110, onto the substrate 2 from the supply tank 31 through the discharge nozzle 32. Therefore, the plating liquid 35 can be reused multiple times.

Further, the supplementing tank 172 is connected to the supply tank 31. The supplementing tank 172 is configured to store therein the unused plating liquid 35 and supply the unused plating liquid 35 into the supply tank 31. The ammonia gas storage unit 170 is also connected to this supplementing tank 172, and a concentration of an ammonia component in the plating liquid 35 stored in the supplementing tank 172 is maintained within a preset target range.

An operation of the second example embodiment having the above-described configuration will be explained. Here, a method of collecting a used Ni plating liquid and recycling the used Ni plating liquid will be described with reference to FIG. 11. In a flowchart of FIG. 11, the same processes as those of the first example embodiment shown in FIG. 9 will be assigned same reference numerals, and detailed description thereof will be omitted.

(Collecting Process)

The plating liquid 85 after used in performing a Ni plating process on the substrate 2 is dispersed from the substrate 2 and reaches the discharge opening 124. The used plating liquid 85 reaching the discharge opening 124 is then collected into the collecting tank 88 through the collecting flow path 122 of the liquid draining device 120 (block S321).

(Composition Adjusting Process)

Thereafter, by using the aforementioned supplementing unit, a component deficient in the used plating liquid 85 is added (block S322). At this time, the plating liquid 85 is agitated by using the agitating unit 81 to allow the added component to be mixed with the used plating liquid 85 sufficiently.

(Supplying Process)

Thereafter, the plating liquid 85 of which a composition is appropriately adjusted in the collecting tank 88 is supplied into the supply tank 31 via the connection line 83 (block S323), as illustrated in FIG. 10.

The Ni plating method using the collected and recycled plating liquid are substantially the same as the Ni plating method in the first example embodiment. Thus, detailed description thereof will be omitted.

(Effect of Second Example Embodiment)

In accordance with the second example embodiment, the used plating liquid 85 is collected and recycled by the plating liquid collecting device 80. Thus, the plating liquid can be utilized more effectively, and cost for the plating liquid can be reduced.

Further, since the plating liquid collecting device 80 is provided as a separate device from the supply tank 31, a plating liquid of which a composition has been appropriately adjusted can be stored in the supply tank, and the plating liquid can be supplied more stably.

Further, in accordance with the present example embodiment, the effect of increasing the lifetime of the plating liquid 35 can be further enhanced by heating the plating liquid 35 through two stages by using the first heating device 50 and the second heating device 60 (see FIG. 10).

### EXPLANATION OF CODES

1: Plating system
2: Substrate
20: Plating apparatus
30: Plating liquid supplying device
31: Supply tank
32: Discharge nozzle
33: Plating liquid supplying line
35: Plating liquid
50: First heating device
51: Supply tank circulating/heating unit
52: Supply tank circulating line
54: Supply tank heater
57: Monitoring unit
60: Second heating device
61: Second temperature medium supplying unit
62: Temperature controller
80: Plating liquid collecting device
81: Agitating unit
82: Collecting tank circulating line
85: Used plating liquid
87: Monitoring unit
88a: Supplementing unit
90: Cleaning liquid supplying device
95: Rinse liquid supplying device
110: Substrate holding/rotating device
120: Plating liquid discharging device
120A: Cooling buffer
122: Collecting flow path
161: Storage medium
170: Ammonia gas storage unit
172: Supplementing tank
174A: Ammonia water supplying unit
174B: Pure water supplying unit

1. A plating apparatus that performs a plating process by supplying a plating liquid containing at least an ammonia component onto a substrate, the plating apparatus comprising:
a substrate accommodating unit configured to accommodate therein the substrate;
a plating liquid supplying device, configured to supply the plating liquid onto the substrate accommodated in the substrate accommodating unit, having a supply tank configured to store therein the plating liquid to be supplied onto the substrate, a discharge nozzle configured to discharge the plating liquid onto the substrate and a plating liquid supplying line through which the plating liquid within the supply tank is supplied into the discharge nozzle;
a plating liquid draining device configured to drain the plating liquid supplied onto the substrate out of the substrate accommodating unit and supply the drained plating liquid to the supply tank of the plating liquid supplying device;
an ammonia gas storage unit which is filled with an ammonia gas and hermetically sealed; and
an ammonia gas line through which the ammonia gas from the ammonia gas storage unit is supplied into the supply tank.

2. The plating apparatus of claim 1, further comprising:
an ammonia water supplying unit configured to supply ammonia water; and
a pure water supplying unit configured to supply pure water,
wherein the ammonia water supplying unit and the pure water supplying unit are connected to the supply tank, respectively.

3. The plating apparatus of claim 2, further comprising:
an ammonia concentration meter,
a pH meter; and
a controller configured to control the ammonia water supplying unit and the pure water supplying unit,
wherein, based on signals from the ammonia concentration meter and the pH meter, the controller is configured to control the ammonia water supplying unit to supply the ammonia water into the supply tank, and control the pure water supplying unit to supply the pure water into the supply tank.

4. The plating apparatus of claim 1, further comprising:
a supplementing tank configured to store therein an unused plating liquid and supplement the supply tank with the unused plating liquid,
wherein the supplementing tank is connected to the ammonia gas storage unit.

5. The plating apparatus of claim 1, further comprising:
a collecting tank configured to collect the plating liquid drained from the plating liquid draining device and supply the collected plating liquid into the supply tank,
wherein the collecting tank is provided between the plating liquid draining device and the supply tank, and the ammonia gas storage unit is connected to the collecting tank.

6. The plating apparatus of claim 1, further comprising:
a cooling buffer that is provided at an outlet side of the substrate accommodating unit and configured to cool the plating liquid and supply the cooled plating liquid into the supply tank.

7. The plating apparatus of claim 1, further comprising:
a first heating device that is provided at either one of the supply tank and the plating liquid supplying line and configured to heat the plating liquid to a first temperature; and
a second heating device that is provided at the plating liquid supplying line between the first heating device and the discharge nozzle and configured to heat the plating liquid to a second temperature higher than the first temperature.

8. A plating method of performing a plating process by supplying a plating liquid containing at least an ammonia component onto a substrate, the plating method comprising:
accommodating the substrate in a substrate accommodating unit;
discharging the plating liquid within a supply tank onto the substrate through a discharge nozzle;
collecting the plating liquid supplied onto the substrate from the substrate accommodating unit through a plating liquid draining device;
adjusting a composition of the collected plating liquid by exposing the collected plating liquid to an ammonia gas; and
supplying the plating liquid of which the composition is adjusted into the discharge nozzle.

9. The plating method of claim 8,
wherein, in the adjusting of the composition of the plating liquid, ammonia water and pure water are supplied based on an ammonia concentration and a pH value of the collected plating liquid.

10. The plating method of claim 8,
wherein, in the adjusting of the composition of the plating liquid, an unused plating liquid exposed to the ammonia gas within a supplementing tank is added to the collected plating liquid.

11. The plating method of claim 8,
wherein, in the collecting of the plating liquid, the plating liquid drained through the plating liquid draining device is collected into a collecting tank, and
in the adjusting of the composition of the plating liquid, the composition of the collected plating liquid is adjusted within the collecting tank, and the plating liquid of which the composition is adjusted is supplied from the collecting tank into the supply tank.

12. The plating method of claim 8,
wherein, in the collecting of the plating liquid, the plating liquid drained from the substrate accommodating unit is cooled.

13. The plating method of claim 8,
wherein, in the discharging of the plating liquid, the plating liquid is discharged onto the substrate through the discharge nozzle, after the plating liquid is first heated to a first temperature by a first heating device and then further heated to a second temperature by a second heating device disposed between the first heating device and the discharge nozzle.

14. A computer-readable storage medium having stored thereon a computer-executable instructions that, in response to execution, cause a plating apparatus to perform a plating method by supplying a plating liquid containing at least an ammonia component onto a substrate,
wherein the plating method comprises:
accommodating the substrate in a substrate accommodating unit;
discharging the plating liquid within a supply tank onto the substrate through a discharge nozzle;
collecting the plating liquid supplied onto the substrate from the substrate accommodating unit through a plating liquid draining device;
adjusting a composition of the collected plating liquid by exposing the collected plating liquid to an ammonia gas; and
supplying the plating liquid of which the composition is adjusted into the discharge nozzle.
